(19) United States
(12) Patent Application Publication
(10) Pub. No.: US 2010/0083584 A1
(43) Pub. Date: Apr. 8, 2010

(54) DISPERSION COMPRISING CERIUM OXIDE AND SHEET SILICATE

(75) Inventors: Michael Kroell, Linsengericht (DE); Stefan Heberer, Offenbach (DE); Katharina Dauth, Offenbach (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: EVONIK DEGUSSA GmbH, Essen (DE)

(21) Appl. No.: 12/522,717

(22) PCT Filed: Dec. 19, 2007
(86) PCT No.: PCT/EP2007/064267

§ 371 Date: Jul. 10, 2009

(30) Foreign Application Priority Data
Feb. 20, 2007 (DE) 102007008279.9

(51) Int. Cl. C09G 1/02; C09K 3/14

(52) U.S. Cl. 51/308

(57) ABSTRACT

A dispersion comprising cerium oxide particles and particles of one or more sheet silicates, where the zeta potential of the sheet silicate particles is negative and that of the cerium oxide particles is positive or equal to zero, and the zeta potential of the dispersion is negative overall, the mean particle diameter of the cerium oxide particles and the mean particle diameter of the sheet silicate particles is not more than 100 nm and the pH of the dispersion is from 7.5 to 10.5, preferably from 9 to 10.

The invention relates to a dispersion which comprises particles of cerium oxide and of sheet silicates, and to its production and use.

It is known that cerium oxide dispersions can be used to polish glass surfaces, metal surfaces and dielectric surfaces, both for coarse polishing (high material removal, irregular profile, scratches) and for fine polishing (low material removal, smooth surfaces, few scratches, if any). A disadvantage is often found to be that cerium oxide particles and the surface to be polished bear different electrical charge and attract one another as a result. As a consequence, it is difficult to remove the cerium oxide particles from the polished surface again.

U.S. Pat. No. 7,112,123 discloses a dispersion for polishing glass surfaces, metal surfaces and dielectric surfaces, which comprises, as an abrasive, from 0.1 to 50% by weight of cerium oxide particles and from 0.1 to 10% by weight of clay abrasive particles, 90% of the clay abrasive particles having a particle diameter of from 10 nm to 10 μm and 90% of the cerium oxide particles having a particle diameter of from 100 nm to 10 μm. Cerium oxide particles, clay abrasive particles and glass as the surface to be polished have a negative surface charge. Such a dispersion enables significantly higher material removal than a dispersion based only on cerium oxide particles. However, such a dispersion causes a high defect rate.

What are desired are dispersions which afford a high material removal rate with a low defect rate and high selectivity. After the polishing and cleaning of the wafers, only a small amount of deposits, if any, should be present on the surface.

It has now been found that, surprisingly, the object is achieved by a dispersion which comprises cerium oxide particles and particles of one or more sheet silicates, where
the zeta potential of the sheet silicate particles is negative and that of the cerium oxide particles is positive or equal to zero, and the zeta potential of the dispersion is negative overall,
the mean particle diameter of the cerium oxide particles and the mean particle diameter of the sheet silicate particles is not more than 200 nm and
the pH of the dispersion is from 7.5 to 10.5, preferably from 9 to 10.

One measure of the surface charge of the particles is the zeta potential. The zeta potential is understood to mean the potential at the shear level within the electrochemical double layer of particle/electrolyte in the dispersion. An important parameter in connection with the zeta potential is the isoelectric point (IEP) for a particle. The IEP specifies the pH at which the zeta potential is zero. The greater the zeta potential, the more stable is the dispersion.

The charge density at the surface can be influenced by changing the concentration of the potential-determining ions in the surrounding electrolyte.

Particles of the same material will have the same sign of the surface charges and thus repel one another. When the zeta potential is too small, the repulsive force, however, cannot compensate for the van der Waals attraction of the particles, and there is flocculation and possibly sedimentation of the particles.

The zeta potential can, for example, be determined by measuring the colloidal vibration current (CVI) of the dispersion or by determining the electrophoretic mobility.

Moreover, the zeta potential can be determined by means of the electrokinetic sound amplitude (ESA).

The proportion of cerium oxide in the inventive dispersion can be varied over a wide range. The cerium oxide content may preferably be from 0.01 to 50% by weight based on the dispersion. High contents are desired when the intention is, for example, to minimize transport costs. In the case of use as a polishing agent, the content of cerium oxide is preferably from 0.1 to 5% by weight and more preferably from 0.2 to 1% by weight, based on the dispersion.

The content of sheet silicate is preferably from 0.01 to 10% by weight and more preferably from 0.05 to 0.5% by weight, based on the dispersion.

In addition, it has been found to be advantageous in polishing processes when the cerium oxide/sheet silicate weight ratio is from 1:2 to 100:1. A weight ratio of from 10:1 to 2:1 is particularly preferred.

Moreover, preference may be given to an inventive dispersion in which, apart from cerium oxide particles and sheet silicate particles, no further particles are present.

The mean particle diameter of the cerium oxide particles in the inventive dispersion is not more than 100 nm. Preference is given to a range from 40 to 90 nm. Within this range, the best results arise in polishing processes with regard to material removal, selectivity and defect rate.

The cerium oxide particles may be present as isolated individual particles, or else in the form of aggregated primary particles. The inventive dispersion preferably comprises aggregated cerium oxide particles, or the cerium oxide particles are present predominantly or completely in aggregated form.

Particularly suitable cerium oxide particles have been found to be those which contain carbonate groups on their surface and in layers close to the surface, especially those as disclosed in DE-A-102005038136. These are cerium oxide particles which
have a BET surface area of from 25 to 150 m²/g,
the primary particles have a mean diameter of from 5 to 50 nm,
the layer of the primary particles close to the surface has a depth of approx. 5 nm,
in the layer close to the surface, the carbonate concentration, proceeding from the surface at which the carbonate concentration is at its highest, decreases toward the interior,
the carbon content on the surface which stems from the carbonate groups is from 5 to 50 area percent and, in the layer close to the surface, is from 0 to 30 area percent in a depth of approx. 5 nm
the content of cerium oxide, calculated as CeO₂ and based on the powder, is at least 99.5% by weight and
the content of carbon, comprising organic and inorganic carbon, is from 0.01 to 0.3% by weight, based on the powder.

The carbonate groups can be detected both at the surface and in a depth up to approx. 5 nm of the cerium oxide particles. The carbonate groups are chemically bonded and may, for example, be arranged as in the structures a-c.

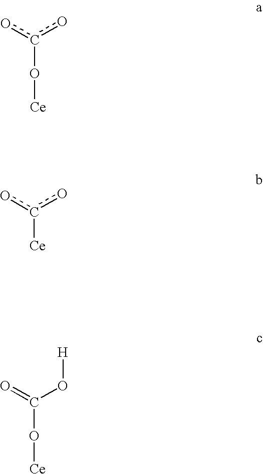

The carbonate groups can be detected, for example, by XPS/ESCA analysis. To detect the carbonate groups in the layer close to the surface, some of the surface can be ablated by means of argon ion bombardment, and the new surface which arises can likewise be analyzed by means of XPS/ESCA (XPS=X-ray Photoelectron Spectroscopy; ESCA=Electron Spectroscopy for Chemical Analysis).

The content of sodium is generally not more than 5 ppm and that of chlorine not more than 20 ppm. The elements mentioned are generally tolerable only in small amounts in chemical-mechanical polishing.

The cerium oxide particles used preferably have a BET surface area of from 30 to 100 m²/g and more preferably of 40-80 m²/g.

The inventive dispersion comprises, as well as the cerium oxide particles, also sheet silicate particles.

In the sheet silicates, each tetrahedron is already bonded to three neighboring tetrahedrons via three corners. The linkage is effected so as to form two-dimensionally infinite tetrahedral networks between which lie layers of cations surrounded octahedrally by O⁻ and (OH)⁻, for example K⁺, Li⁺, Mg²⁺, Zn²⁺, Fe²⁺, Fe³⁺, Mn²⁺. In the tetrahedral layers, all free tetrahedral tips point in one direction.

When the tetrahedrons of one layer are joined to form individual or double networks of six-membered rings, hexagonal or pseudohexagonal minerals arise, as in the mica family (muscovite, biotite), chlorite series (clinochlore) and kaolinite-serpentinite family (chrysotile, kaolinite). When the layer, in contrast, consists of four-membered rings, the mineral is tetragonal or pseudotetragonal (e.g. apophyllite).

The sheet silicates include talc, mica group (seladonite, paragonite, muscovite, phlogopite, annite/biotite, trilithionite/lepidolite, margarite), clay minerals (montmorillonite group, chlorite group, kaolinite group, serpentine group, sepiolite, gyrolite, cavansite, pentagonite).

Preferably, the inventive dispersion comprises a synthetic sheet silicate. This is preferably selected from the group consisting of natural and synthetic montmorillonites, bentonites, hectorites, smectites and talc.

The sheet silicate particles present in the inventive dispersion preferably have a mean diameter in the range from 5 to 100 nm. The mean particle diameter of the sheet silicates should be understood to mean the diameter in the longitudinal direction, i.e. in the direction of greatest expansion of the particles.

Moreover, the aspect ratio of the sheet silicate particles, i.e. the ratio of longitudinal dimension to thickness, is preferably greater than 5 and more preferably greater than 20.

Particular preference is given to an inventive dispersion in which the sheet silicate is a synthetic lithium magnesium silicate of the composition 59±2% by weight of SiO₂, 27±2% by weight of MgO, 0.7±0.2% by weight of Li₂O, 3.0±0.5% by weight of Na₂O and <10% by weight of H₂O.

Particular preference is further given to an inventive dispersion in which the sheet silicate is one based on montmorrillonite with a particle diameter of from 10 to 200 nm and a thickness of from 1 to 10 nm. The aspect ratio of this sheet silicate is preferably >100.

In the inventive dispersion, the mean particle diameter of the cerium oxide particles is preferably greater than that of the sheet silicate particles.

The inventive dispersion features, inter alia, a mean particle diameter of the cerium oxide particles and a mean particle diameter of the sheet silicate particles of not more than 200 nm. The mean particle diameter of the cerium oxide particles is preferably greater than that of the sheet silicate particles. In particular, preference is given to an embodiment of the inventive dispersion in which the mean particle diameter of the cerium oxide particles is from 40 to 90 nm and that of the sheet silicate particles is from 5 to 15 nm.

It has been found to be particularly advantageous when the cerium oxide particles, on their surface and in layers close to the surface, comprise carbonate groups and the pH of the dispersion is from 9 to 10.

The inventive dispersion preferably has a zeta potential of from −20 to −100 mV, more preferably a zeta potential of from −25 to −50 mV.

The liquid phase of the inventive dispersion comprises water, organic solvents and mixtures of water with organic solvents. In general, the main constituent, with a content of >90% by weight of the liquid phase, is water.

In addition, the inventive dispersion may also comprise acids, bases, salts. The pH can be adjusted by means of acids or bases. The acids used may be inorganic acids, organic acids or mixtures of the aforementioned. The inorganic acids used may in particular be phosphoric acid, phosphorous acid, nitric acid, sulfuric acid, mixtures thereof, and their acidic salts. The organic acids used are preferably carboxylic acids of the general formula CₙH₂ₙ₊₁CO₂H, where n=0-6 or n=8, 10, 12, 14, 16, or dicarboxylic acids of the general formula HO₂C(CH₂)ₙCO₂H, where n=0-4, or hydroxycarboxylic acids of the general formula R₁R₂C(OH)CO₂H, where R₁=H, R₂=CH₃, CH₂CO₂H, CH(OH)CO₂H, or phthalic acid or salicylic acid, or acidic salts of the aforementioned acids or mixtures of the aforementioned acids and their salts. The pH can be increased by adding ammonia, alkali metal hydroxides or amines.

In particular applications, it may be advantageous when the inventive dispersion contains 0.3-20% by weight of an oxidizing agent. For this purpose, it is possible to use hydrogen peroxide, a hydrogen peroxide adduct, for example the urea adduct, an organic peracid, an inorganic peracid, an imino peracid, a persulfate, perborate, percarbonate, oxidizing metal salts and/or mixtures of the above. More preferably, hydrogen peroxide may be used. Owing to the reduced stability of some oxidizing agents toward other constituents of the inventive dispersion, it may be advisable not to add them until immediately before the utilization of the dispersion.

The inventive dispersion may further comprise oxidation activators. Suitable oxidation activators may be the metal salts of Ag, Co, Cr, Cu, Fe, Mo, Mn, Ni, Os, Pd, Ru, Sn, Ti, V and mixtures thereof. Also suitable are carboxylic acids, nitriles, ureas, amides and esters. Iron(II) nitrate may be particularly preferred. The concentration of the oxidation catalyst may, depending on the oxidizing agent and the polishing task, be varied within a range between 0.001 and 2% by weight. More preferably, the range may be between 0.01 and 0.05% by weight.

The corrosion inhibitors, which are generally present in the inventive dispersion with a content of from 0.001 to 2% by weight, may be nitrogen-containing heterocycles such as benzotriazole, substituted benzimidazoles, substituted pyrazines, substituted pyrazoles and mixtures thereof.

The invention further provides a process in which
cerium oxide particles and sheet silicate particles, each in powder form, are dispersed in a liquid phase or
sheet silicate particles in powder form are introduced and subsequently dispersed into a predispersion comprising cerium oxide particles or
cerium oxide particles in powder form are introduced and subsequently dispersed into a predispersion comprising sheet silicate particles or
a predispersion comprising cerium oxide particles and a predispersion comprising sheet silicate particles are combined and subsequently dispersed, and
optionally oxidizing agent, oxidation catalyst and/or corrosion inhibitor are added after the dispersion step of variants a) to d).

Suitable dispersing units are especially those which bring about an energy input of at least 200 kJ/m³. These include systems operating by the rotor-stator principle, for example Ultra-Turrax machines, or stirred ball mills. Higher energy inputs are possible with a planetary kneader/mixer. However, the efficacy of this system is combined with a sufficiently high viscosity of the processed mixture in order to introduce the required high shear energies to divide the particles.

High-pressure homogenizers are used to decompress two predispersed suspension streams under high pressure through a nozzle. The two dispersion jets meet one another exactly and the particles grind one another. In another embodiment, the predispersion is likewise placed under high pressure, but the particles collide against armored wall regions. The operation can be repeated as often as desired in order to obtain smaller particle sizes.

Moreover, the energy input can also be effected by means of ultrasound.

The dispersion and grinding apparatus can also be used in combination. Oxidizing agents and additives can be supplied at different times to the dispersion. It may also be advantageous, for example, not to incorporate oxidizing agents and oxidation activators until the end of the dispersion, if appropriate at lower energy input.

The zeta potential of the sheet silicate particles used is preferably from −20 to −100 mV, at a pH of from 7.5 to 10.5.

The zeta potential of the cerium oxide particles used is preferably from 0 to 40 mV, at a pH of from 7.5 to 10.5.

The invention further provides for the use of the inventive dispersion for polishing.

### EXAMPLE

### Analysis

The specific surface area is determined to DIN 66131.

The surface properties are determined by large-area (1 cm²) XPS/ESCA analysis (XPS=X-ray Photoelectronic Spectroscopy; ESCA=Electron Spectroscopy for Chemical Analysis). The evaluation is based on the general recommendations according to DIN Technical Report No. 39, DMA(A)₉₇ of the National Physics Laboratory, Teddington, U.K., and the findings to date regarding the development-accompanying standardization of the “Surface and Micro Range Analyses” working committee NMP816 (DIN). In addition, the comparative spectra available in each case from the technical literature are taken into account. The values are calculated by background subtraction taking account of the relative sensitivity factors of the electron level reported in each case. The data are in area percent. The precision is estimated at +/−5% relative.

The zeta potential is determined in the pH range of 3-12 by means of the electrokinetic sound amplitude (ESA). To this end, a suspension comprising 1% cerium oxide is prepared. The dispersion is effected with an ultrasound probe (400 W). The suspension is stirred with a magnetic stirrer and pumped by means of a peristaltic pump through the PPL-80 sensor of the Matec ESA-8000 instrument. From the starting pH, the potentiometric titration with 5M NaOH commences up to pH 12. The back-titration to pH 4 is undertaken with 5M HNO₃. The evaluation is effected by means of the instrument software version pcava 5.94.

$$ζ = \frac{ESA \cdot η}{φ \cdot Δ ρ \cdot c \cdot \vert G ( α ) \vert \cdot ɛ \cdot {ɛ}_{r}}$$

where
ζ is zeta potential
φ is volume fraction
Δρ is density difference between particles and liquid
c is speed of sound in the suspension
η is viscosity of the liquid
∈ is dielectric constant of the suspension
   |G(α)| is correction for inertia

The mean particle diameters are determined with a Horiba LB-500 particle size analyzer.

### Feedstocks

The feedstocks used to prepare dispersions are a pyrogenic cerium oxide as described in DE-A-102005038136, example 2, and also the synthetic sheet silicate particles Optigel® SH, from Süd-Chemie, and Laponite® D, from Southern Clay Products. Important physicochemical parameters of these substances are reported in table 1.

TABLE 1
Feedstocks

| | | Zeta | Particle | Particle |
|---|---|---|---|---|
| | BET | potential | diameter | thickness |
| | m²/g | mV (ph) | nm | nm |
| Cerium | 60 | 5 (9.5) | 65^{a)} | — |
| oxide | | | | |
| Optigel ® | — | −40 (9.5) | 100 | approx. 1 |
| SH | | | | |
| Laponite ® | — | −58 (9.5) | 10 | approx. 1 |
| D | | | | |

^{a)}determined Horiba LB-500 particle size analyzer

The cerium oxide additionally has the following values: 99.79% by weight of CeO₂, 0.14% by weight of C, zeta potential 48 mV at pH=5, IEP at pH=9.8, C1s synthesized/sputtered 19.0/11.2% by area (sputtered: after ablation of the surface by bombardment with argon ions, 5 keV, approx. 10 min; carbonate C: binding energy approx. 289 eV).

### Wafer/Pad:

Silicon dioxide (200 mm, layer thickness 1000 nm, thermal oxide, from SiMat) and silicon nitride (200 mm, layer thickness 160 nm, LPCVD, from SiMat).

Rodel IC 1000-A3 pad.

### Preparation of the Dispersions

D1: The dispersion is obtained by adding cerium oxide powder to water, and dispersing it by ultrasound treatment with an ultrasound finger (from Bandelin UW2200/DH13G, level 8, 100%; 5 minutes). Subsequently, the pH is adjusted to 7.5 with aqueous ammonia.

D2, D3: The dispersions are obtained by mixing a predispersion consisting of cerium oxide and water and a predispersion consisting of sheet silicate and water, dispersing it by ultrasound treatment with an ultrasound finger (from Bandelin UW2200/DH13G, level 8, 100%; 5 minutes) and subsequently adjusting the pH to 9.5 with aqueous ammonia. Table 2 shows important parameters of the resulting dispersions.

TABLE 2
Dispersions

| | | Dispersion | | |
|---|---|---|---|---|
| | | D1 | D2 | D3 |
| cerium oxide | % by | 0.5 | 0.5 | 0.5 |
| | wt. | | | |
| sheet silicate | % by | — | Optigel ® | Laponite ® D |
| | wt. | 0 | SH | 0.07 |
| | | | 0.1 | |
| pH | | 7.5 | 9.5 | 9.5 |
| zeta potential | mV | 27 | −31 | −28 |
| particle | nm | 65 | 85 | 71 |
| diameter* | | | | |
| 7 d | | | | |
| particle | nm | — | 117 | 113 |
| diameter* | | | | |
| 44 d | | | | |

*weighted to particle number

TABLE 3
Polishing results

| | | | Dispersion | | |
|---|---|---|---|---|---|
| | | | D1 | D2 | D3 |
| RR SiO₂ | nm/min | | 295 | 201 | 245 |
| RR Si₃N₄ | nm/min | after | 88 | 84 | 67 |
| | | makeup | | | |
| SiO₂/Si₃N₄ | | | 3.4 | 2.4 | 3.7 |
| RR SiO₂ | nm/min | | — | 207 | 157 |
| RR Si₃N₄ | nm/min | after | — | 84 | 76 |
| | | 14 d | | | |
| SiO₂/Si₃N₄ | | | — | 2.5 | 2.1 |
| RR SiO₂ | nm/min | | — | 245 | 245 |
| RR Si₃N₄ | nm/min | after | — | 76 | 101 |
| | | 44 d | | | |
| SiO₂/Si₃N₄ | | | — | 3.2 | 2.4 |

Table 3 shows the polishing ablations and selectivities after makeup of the dispersion, after 14 and after 44 days. The use of the inventive dispersions leads to a reduction in the ablation rate compared to a dispersion not containing any sheet silicate particles (D1). However, this is still considered to be satisfactory compared to known dispersions comprising organic additives from the prior art. However, compared to known dispersions from the prior art which comprise organic additives, this should still be described as satisfactory.

### Assessment of Polishing Residues on Wafers and Pads

The polishing residues are assessed visually (also by light microscope in the range of up to 64-fold magnification).

To this end, the particle sizes of dispersions D1 (comparative) and D3 (inventive) are analyzed directly after polishing:
D1 is unstable and sediments as early as after a few minutes. The particle size measured is significantly above one micrometer.
D3, in contrast, is still stable even after polishing and the particle size is approx. 106 nm, weighted to particle number. This means that there is no formation of large agglomerates in the case of the inventive dispersions. The wafer polished with D3 also exhibits a considerably lower level of residues.

The addition of negatively charged sheet silicate particles influences the polishing quality of a cerium oxide-comprising dispersion in a positive manner by reducing the proportion of polishing residues.

One possible mechanism comprises the outward screening of positively charged cerium oxide particles by negatively charged sheet silicate particles, ensuring effective reversal of the charge of the cerium oxide particles. As a result of this reversal of charge, the inventive dispersion offers, inter alia, the possibility of polishing at pH values close to the IEP of the pure cerium oxide. Since the interactions are electrostatic interactions, the sheet silicate particles can be sheared off during the polishing operation, so that the polishing action of the cerium oxide is maintained. As a result of all particles always being outwardly negatively charged during the entire polishing operation and thereafter, agglomerate formation is significantly reduced. Long-term analyses show that the stability and polishing properties are maintained even over prolonged periods.

1. A dispersion comprising cerium oxide particles and particles of one or more sheet silicates, in which
the zeta potential of the sheet silicate particles is negative and that of the cerium oxide particles is positive or equal to zero, and the zeta potential of the dispersion is negative overall,
the mean particle diameter of the cerium oxide particles and the mean particle diameter of the sheet silicate particles are not more than 200 nm and
the pH of the dispersion is from 7.5 to 10.5.

2. The dispersion as claimed in claim 1, wherein the content of cerium oxide is from 0.01 to 50% by weight.

3. The dispersion as claimed in claim 1, wherein the content of cerium oxide is from 0.1 to 5% by weight, based on the dispersion.

4. The dispersion as claimed in claim 1, wherein the content of sheet silicate is from 0.01 to 10% by weight, based on the dispersion.

5. The dispersion as claimed in claim 1, wherein the cerium oxide/sheet silicate weight ratio is from 1:2 to 100:1.

6. The dispersion as claimed in claim 1, wherein cerium oxide particles and sheet silicate particles are the only particles in the dispersion.

7. The dispersion as claimed in claim 1, wherein the mean particle diameter of the cerium oxide particles is from 40 to 90 nm.

8. The dispersion as claimed in claim 1, wherein the cerium oxide particles are present in the form of aggregated primary particles.

9. The dispersion as claimed in claim 1, wherein the cerium oxide particles contain carbonate groups on their surface and in layers close to the surface.

10. The dispersion as claimed in claim 1, wherein the sheet silicate particles have a mean diameter in the range from 5 to 100 nm.

11. The dispersion as claimed in claim 1, wherein the aspect ratio of the sheet silicate particles is greater than 5.

12. The dispersion as claimed in claim 1, wherein the sheet silicate is a synthetic sheet silicate.

13. The dispersion as claimed in claim 1, wherein the sheet silicate is selected from the group consisting of natural and synthetic montmorillonites, bentonites, hectorites, smectites and talc.

14. The dispersion as claimed in claim 1, wherein the sheet silicate is a synthetic lithium magnesium silicate comprising 59±2% by weight of SiO₂, 27±2% by weight of MgO, 0.7±0.2% by weight of Li₂O, 3.0±0.5% by weight of Na₂O and <10% by weight of H₂O.

15. The dispersion as claimed in claim 1, wherein the sheet silicate is one based on montmorrillonite with a particle diameter of from 10 to 200 nm and a thickness of from 1 to 10 nm.

16. The dispersion as claimed in claim 1, wherein the mean particle diameter of the cerium oxide particles is greater than that of the sheet silicate particles.

17. The dispersion as claimed in claim 1, wherein the mean particle diameter of the cerium oxide particles is from 40 to 90 nm and that of the sheet silicate particles from 5 to 15 nm.

18. The dispersion as claimed in claim 1, wherein the cerium oxide particles comprise carbonate groups on their surface and in layers close to the surface, and the pH of the dispersion is from 9 to 10.

19. The dispersion as claimed in claim 1, wherein the zeta potential of the dispersion is from −20 to −100 mV.

20. The dispersion as claimed in claim 1, wherein water is the main constituent of the liquid phase of the dispersion.

21. The dispersion as claimed in claim 1, which comprises a member selected from the group consisting of acids, bases, salts, oxidizing agents, oxidation catalysts and corrosion inhibitors.

22. A process for producing the dispersion as claimed in claim 1, which comprises
a) dispersing cerium oxide particles and sheet silicate particles, each in powder form, in a liquid phase or
b) introducing and subsequently dispersing sheet silicate particles in powder form into a predispersion comprising cerium oxide particles or
c) introducing and subsequently dispersing cerium oxide particles in powder form into a predispersion comprising sheet silicate particles or
d) combining and subsequently dispersing a predispersion comprising cerium oxide particles and a predispersion comprising sheet silicate particles, and
e) optionally adding a member selected from the group consisting of an oxidizing agent, an oxidation catalyst and a corrosion inhibitor after the dispersion of variants a) to d).

23. The process as claimed in claim 22, wherein the zeta potential of the sheet silicate particles is from 20 to 100 mV at a pH of from 7.5 to 10.5.

24. The process as claimed in claim 22, wherein the zeta potential of the cerium oxide particles is from 0 to 40 mV at a pH of from 7.5 to 10.5.

25. A polishing composition comprising the dispersion as claimed in claim 1.
